(19) United States
(12) Patent Application Publication
(10) Pub. No.: US 2024/0274921 A1
(43) Pub. Date: Aug. 15, 2024

(54) BATTERY TEMPERATURE RAISING SYSTEM

(71) Applicant: TOYOTA JIDOSHA KABUSHIKI KAISHA, Aichi-ken (JP)

(72) Inventor: Takayuki SHIMAUCHI, Toyota-shi (JP)

(21) Appl. No.: 18/434,697

(22) Filed: Feb. 6, 2024

(30) Foreign Application Priority Data
Feb. 10, 2023 (JP) 2023-019104

(51) Int. Cl. H01M 10/6568; H01M 10/613; H01M 10/615; H01M 10/625; H01M 10/6571; H01M 10/663; H01M 50/249

(52) U.S. Cl. CPC H01M 10/6568; H01M 10/613; H01M 10/615; H01M 10/625; H01M 10/6571; H01M 10/663; H01M 50/249; H01M 2220/20

(57) ABSTRACT

The battery temperature raising system is a battery temperature raising system that raises the temperature of a battery mounted on a vehicle, and includes a battery cooling water circuit configured to cool or heat the battery to an appropriate temperature, and an engine cooling water circuit that cools the engine. The engine cooling water circuit has a first path for heating the battery cooling water circuit, a second path for heating air blown into the vehicle compartment, and a third path for heating by the heater. The first path is connected in parallel with the second path.

### CROSS REFERENCE TO RELATED APPLICATION

This application claims priority to Japanese Patent Application No. 2023-019104 filed on Feb. 10, 2023, which is incorporated herein by reference in its entirety including the specification, claims, drawings, and abstract.

### TECHNICAL FIELD

The present disclosure relates to a battery temperature raising system for raising a temperature of a battery mounted on a vehicle.

### BACKGROUND

The amount of charge in the battery mounted on the vehicle is suppressed when the temperature of the battery is low from the viewpoint of characteristic degradation and lifetime. Therefore, the battery charging efficiency is improved by increasing the temperature of the battery during charging, and the charging time is shortened. For example, Japanese Patent Application JPH11-222027 discloses a technique of heating a battery to an appropriate temperature by using exhaust heat of an engine cooling water circuit.

### SUMMARY

However, in the engine cooling water circuit disclosed in JPH11-222027, a battery heat exchanger for heating a battery to an appropriate temperature and a heater core for heating air blown into a vehicle compartment are connected in series. Therefore, in the engine cooling water circuit, when the cooling water is circulated to the battery heat exchanger, the heater core becomes a resistance, and the flow rate of the cooling water to the battery heat exchanger cannot be sufficiently ensured, so that the temperature of the battery cannot be sufficiently increased.

Accordingly, an object of the present disclosure is to provide a battery temperature raising system capable of improving the ability to raise the temperature of a battery.

A battery temperature raising system according to the present disclosure is a battery temperature raising system that raises a temperature of a battery mounted on a vehicle, and includes a battery cooling water circuit configured to cool or heat a battery to an appropriate temperature, and an engine cooling water circuit that cools an engine. The engine cooling water circuit has a first path for heating the battery cooling water circuit, a second path for heating air blown into the vehicle compartment, and a third path for heating by the heater. The first path is connected in parallel with the second path.

According to the above configuration, the resistance of the first path for heating the battery cooling water circuit is reduced, the flow rate of the first path can be sufficiently ensured, and the ability to raise the temperature of the battery can be improved.

In the battery temperature raising system according to the present disclosure, at least one embodiments include the third path connected in series with the first path and the second path, and the engine cooling water circuit has a bypass path for bypassing the third path.

According to the above configuration, the resistance of the first path for heating the battery cooling water circuit is reduced, the flow rate of the first path can be sufficiently ensured, and the ability to raise the temperature of the battery can be improved.

In the battery temperature raising system according to the present disclosure, when the battery temperature is equal to or lower than a predetermined temperature and the temperature of the water in the engine cooling water circuit is higher than the battery temperature, the battery cooling water circuit is heated only by the exhaust heat from the engine. After the battery cooling water circuit is heated by the exhaust heat from the engine, when the battery temperature is equal to or lower than a predetermined temperature and the difference between the water temperature of the engine cooling water circuit and the battery temperature is equal to or lower than a predetermined temperature, in at least one embodiment the battery cooling water circuit is heated by heating the heater.

According to the above configuration, the battery can be efficiently heated by heating by the heater after heating by the engine exhaust heat in the engine cooling water circuit.

According to the battery temperature raising system of the present disclosure, the ability to raise the temperature of the battery can be improved.

### BRIEF DESCRIPTION OF DRAWINGS

FIG. 1 is a circuit diagram showing a battery temperature raising system according to an embodiment.

FIG. 2 is a circuit diagram showing a case where the temperature of a battery is increased only by engine exhaust heat.

FIG. 3 is a circuit diagram showing a case where the temperature of the battery is increased by exhaust heat of the engine and heating of the heater.

FIG. 4 is a circuit diagram showing a case where the temperature of a battery is increased only by a heater.

FIG. 5 is a block diagram showing a configuration of a control unit.

FIG. 6 is a flowchart showing a flow of battery temperature rise control.

### DESCRIPTION OF EMBODIMENTS

Hereinafter, an example of an embodiment of the present disclosure will be described in detail. In the following description, specific shapes, materials, directions, numerical values, and the like are examples for facilitating understanding of the present invention, and can be appropriately changed in accordance with applications, purposes, specifications, and the like.

The battery temperature raising system 10 is a system for raising the temperature of a battery 12 mounted on a vehicle (not shown). According to the battery temperature raising system 10, although described in detail later, the ability to raise the temperature of the battery 12 can be improved.

The vehicle of the present embodiment is an HEV (Hybrid Electric Vehicle) that runs by driving an engine 11 and a motor (not shown). The motor is powered by a battery 12.

### [Battery Temperature System]

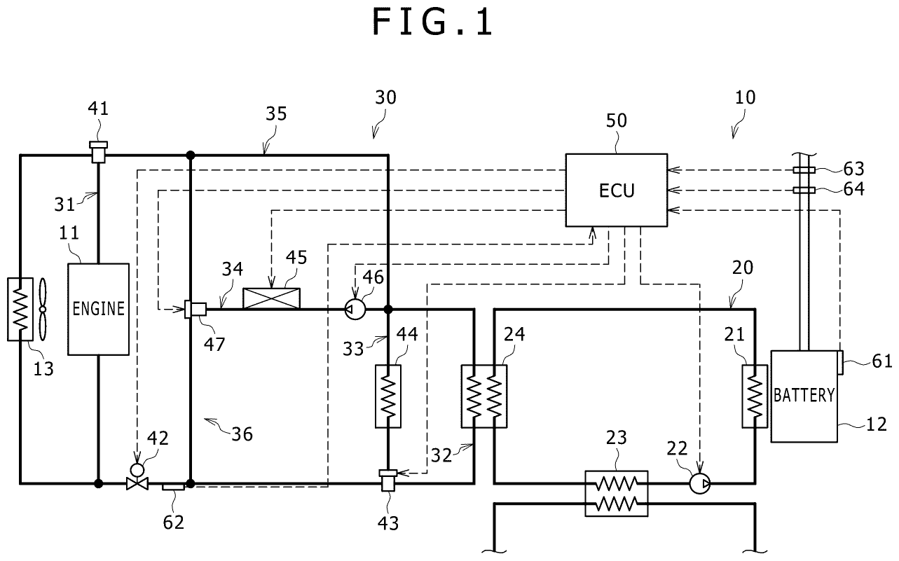

A configuration of a battery temperature raising system 10 as an example of an embodiment will be described with reference to FIGS. 1 to 4.

The battery temperature raising system 10 includes a battery cooling water circuit 20 that cools or heats the battery 12 to an appropriate temperature by circulating cooling water, an engine cooling water circuit 30 that cools the engine 11 by circulating cooling water, and ECU (Electronic Control Unit) 50 as a control unit that controls each device of the battery cooling water circuit 20 and the engine cooling water circuit 30.

### [Battery Cold Circuit]

The battery cooling water circuit 20 cools or heats the battery 12 to an appropriate temperature by circulating heated or cooled cooling water in a battery heat exchanger 21 provided adjacent to the battery 12. The battery cooling water circuit 20 includes the battery heat exchanger 21, a pump 22, a chiller 23, and a water-water heat exchanger 24, which will be described in detail later.

Cooling water in the battery cooling water circuit 20 is circulated by the pump 22. The chiller 23 is connected to a refrigeration cycle circuit (not shown), and cools the water circulating in the battery cooling water circuit 20 by the refrigerant circulating in the refrigeration cycle circuit.

The water-water heat exchanger 24 exchanges heat between cooling water circulating in the engine cooling water circuit 30 and cooling water circulating in the battery cooling water circuit 20. More specifically, the water-water heat exchanger 24 heats the cooling water circulating in the battery cooling water circuit 20 by the cooling water circulating in the engine cooling water circuit 30.

With the above configuration, in the battery cooling water circuit 20, the coolant circulated by the pump 22 is heated by the water-water heat exchanger 24, whereby the battery heat exchanger 21 is heated to heat the battery 12 at an appropriate temperature. In the battery cooling water circuit 20, cooling water circulated by the pump 22 is cooled by the chiller 23, whereby the battery heat exchanger 21 is cooled to cool the battery 12.

### [Engine Cooling Water Circuit]

In the engine cooling water circuit 30, the engine 11 is cooled by circulation of the cooling water, the cooling water circulating in the battery cooling water circuit 20 is heated by circulation of the cooling water, air blown into the vehicle compartment is cooled by circulation of the cooling water, and the cooling water is heated by the heater 45.

The engine cooling water circuit 30 includes an engine cooling path 31, a battery temperature raising path 32 as a first path, a heater core path 33 as a second path, a heater path 34 as a third path, a heater bypass path 35 as a bypass path, and an engine bypass path 36. The engine cooling path 31 cools the engine 11. The battery temperature raising path 32 heats the battery cooling water circuit 20. The heater core path 33 heats air blown into the vehicle compartment. The heater path 34 is heated by a heater 45. The heater bypass path 35 bypasses the heater path 34. The engine bypass path 36 bypasses the engine 11.

The engine cooling path 31 cools the engine 11 by circulating cooling water in a cooling passage formed in a cylinder head and a cylinder block of the engine 11 by a pump (not shown) driven by power of the engine 11. Further, the radiator 13 is connected in parallel with the engine cooling path 31, and when the cooling water is equal to or higher than a predetermined temperature by a three-way valve having the thermostat 41, the cooling water can be circulated through the radiator 13 to cool the cooling water. Further, a flow shutting valve 42 for opening and closing the engine cooling path 31 is provided on the downstream side of the engine 11.

The battery temperature raising path 32 as the first path heats the cooling water circulating in the battery cooling water circuit 20. The above-described water-water heat exchanger 24 connected to the battery cooling water circuit 20 is provided in the battery temperature raising path 32. The battery temperature raising path 32 is connected to the downstream side of the engine cooling path 31, and is connected in parallel with the heater core path 33. A three-way regulator valve 43 is provided at a branch portion between the battery temperature raising path 32 and the heater core path 33. The three-way control valve 43 can adjust the flow rate from the engine cooling path 31 to the battery temperature raising path 32, and the flow rate from the engine cooling path 31 to the heater core path 33.

Here, in the engine cooling water circuit 30, since the battery temperature raising path 32 and the heater core path 33 are connected in parallel, the cooling water circulating in the battery temperature raising path 32 is not subjected to the resistance of the heater core 44 described later. Therefore, the circulation amount of the cooling water circulating in the battery temperature raising path 32 can be sufficiently ensured, and the ability to raise the temperature of the battery 12 can be improved.

The heater core path 33 as the second path heats air blown into the vehicle compartment. A heater core 44 for heating air blown into the vehicle compartment in an air conditioner for air conditioning the vehicle compartment is provided in the heater core path 33. The heater core path 33 is connected to the downstream side of the engine cooling path 31 and is connected in parallel with the battery temperature raising path 32.

The heater path 34 serving as the third path is heated by the heater 45. A heater 45 and a pump 46 are provided in the heater path 34. The heater path 34 is connected in series with the battery temperature raising path 32 and the heater core path 33, and is connected to the downstream side of the battery temperature raising path 32 and the heater core path 33.

The heater bypass path 35 serving as a bypass path is connected in parallel with the heater path 34 and bypasses the heater path 34. According to the heater bypass path 35, although details will be described later, the circulation amount of the cooling water circulating in the battery temperature raising path 32 can be sufficiently ensured, and the ability to raise the temperature of the battery 12 can be improved. Further, an increase in power of the heater 45 can be suppressed.

The engine bypass path 36 is a path for bypassing the engine 11, and connects the engine cooling path 31 and the heater path 34. A three-way switching valve 47 is provided at a connection portion between the engine bypass path 36 and the heater path 34. The three-way switching valve 47 switches communication between the engine bypass path 36 and the heater path 34 and communication between the heater path 34 and the engine cooling path 31.

### [First Mode (Only Engine Exhaust Heat)]

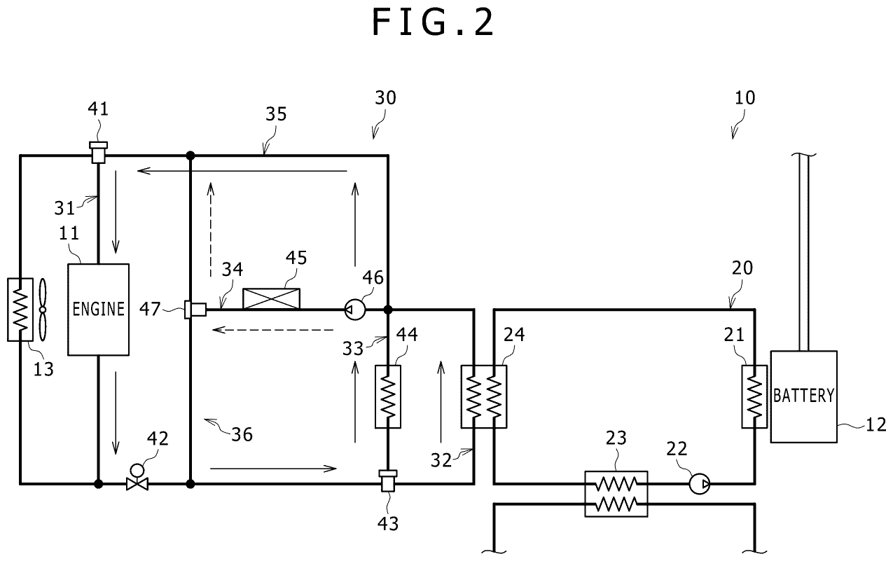

As shown in FIG. 2, the battery cooling water circuit 20 and/or the heater core 44 may be heated only by the exhaust heat of the engine 11 in the engine cooling water circuit 30 (hereinafter referred to as a first mode). In the first mode, the flow shutting valve 42 is opened, the three-way control valve 43 is adjusted based on the heating load of the air conditioner and the battery temperature, the pump 46 is stopped, and the three-way switching valve 47 is switched to the communication between the heater path 34 and the engine cooling path 31. In the first mode, the cooling water is heated by the exhaust heat of the engine 11, heating the heater core 44 and/or the water-water heat exchanger 24, respectively, and returning to the engine 11 via the heater bypass path 35.

According to the first mode, most of the circulating cooling water does not pass through the heater path 34, and does not receive the resistance of the heater 45 and the pump 46. Therefore, the circulation amount of the cooling water circulating in the battery temperature raising path 32 can be sufficiently ensured, and the ability to raise the temperature of the battery 12 can be improved.

Since the resistance of the heater path 34 is larger than that of the heater bypass path 35, a small amount of cooling water flows through the heater path 34 in comparison with the heater bypass path 35.

For example, if the cooling water is not circulated in the heater path 34 in the first mode, the cooling water retained in the heater path 34 is cooled by the outside air temperature. In this state, when the mode is shifted from the first mode to a second mode described later, it is necessary to heat the cooling water retained in the heater path 34 by the heater 45, which leads to an increase in power of the heater 45. Further, when the mode is shifted from the first mode to the second mode, the cooling water retained in the heater path 34 and cooled flows into the heater core path 33, and the heater core 44 is not sufficiently heated, whereby the blowout temperature at the time of heating of the air conditioner may be lowered.

However, in the engine cooling water circuit 30 of the present embodiment, a small amount of cooling water heated by the exhaust heat of the engine 11 circulates in the heater path 34 in the first mode, and when the mode is shifted from the first mode to the second mode, the power increase of the heater 45 described above can be suppressed. Further, when the mode is shifted from the first mode to the second mode, the heater core 44 is sufficiently heated, so that the blowout temperature at the time of heating of the air conditioner is not reduced.

In the first mode, the three-way control valve 43 is adjusted based on the heating load of the air conditioner and the temperature of the battery 12, but if the heating load of the air conditioner is 0, cooling water may be circulated only in the water-water heat exchanger 24. If it is not necessary to raise the temperature of the battery 12, cooling water may be circulated only in the heater core 44. The same applies to the following second mode and third mode.

### [Second Mode (Engine Exhaust Heat and Heater Heating)]

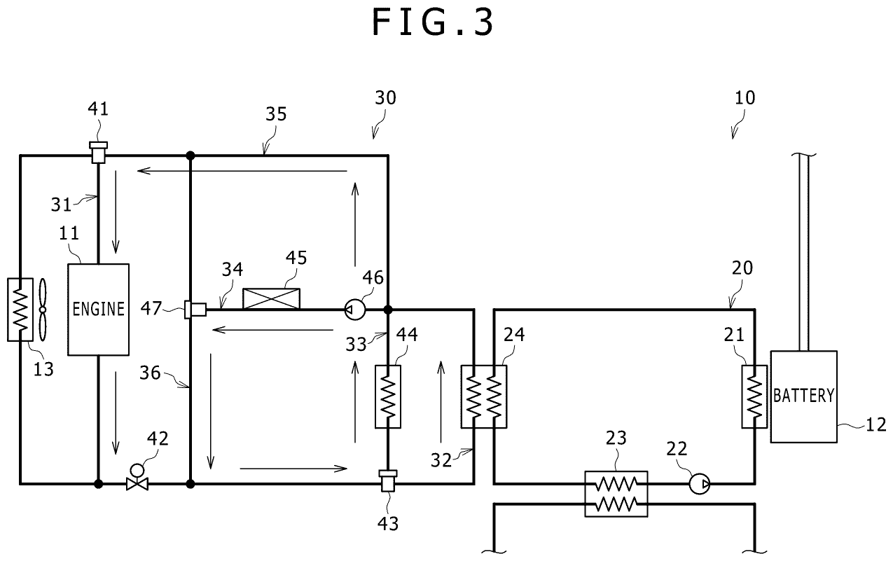

As shown in FIG. 3, the battery cooling water circuit 20 and/or the heater core 44 may be heated by the exhaust heat of the engine 11 and the heating of the heater 45 in the engine cooling water circuit 30 (hereinafter referred to as a second mode). In the second mode, the flow shutting valve 42 is opened, the three-way control valve 43 is adjusted based on the heating load of the air conditioner and the battery temperature, the pump 46 is driven, and the three-way switching valve 47 is switched to the communication between the heater path 34 and the engine bypass path 36. In the second mode, the cooling water is heated by the exhaust heat of the engine 11, the cooling water is heated by the heater 45, the heater core 44 and the water-water heat exchanger 24 are heated by the cooling water, and the cooling water returns to the engine 11 or the heater path 34 via the heater bypass path 35.

### [Third Mode (Only Heater Heating)]

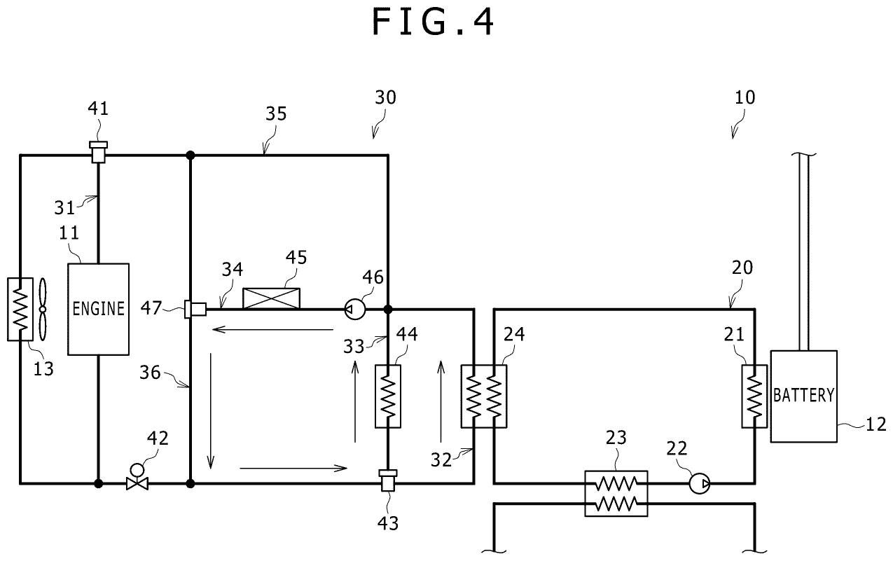

As shown in FIG. 4, the battery cooling water circuit 20 and the heater core 44 may be heated only by heating the heater 45 in the engine cooling water circuit 30 (hereinafter referred to as a third mode). In the third mode, the flow shutting valve 42 is closed, the three-way control valve 43 is adjusted based on the heating load of the air conditioner and the battery temperature, the pump 46 is driven, and the three-way switching valve 47 is switched to the communication between the heater path 34 and the engine bypass path 36. In the third mode, the cooling water is heated by the heater 45, the heater core 44 and/or the water-water heat exchanger 24 are heated by the cooling water, and the cooling water returns to the heater path 34.

### [Control Unit (ECU)]

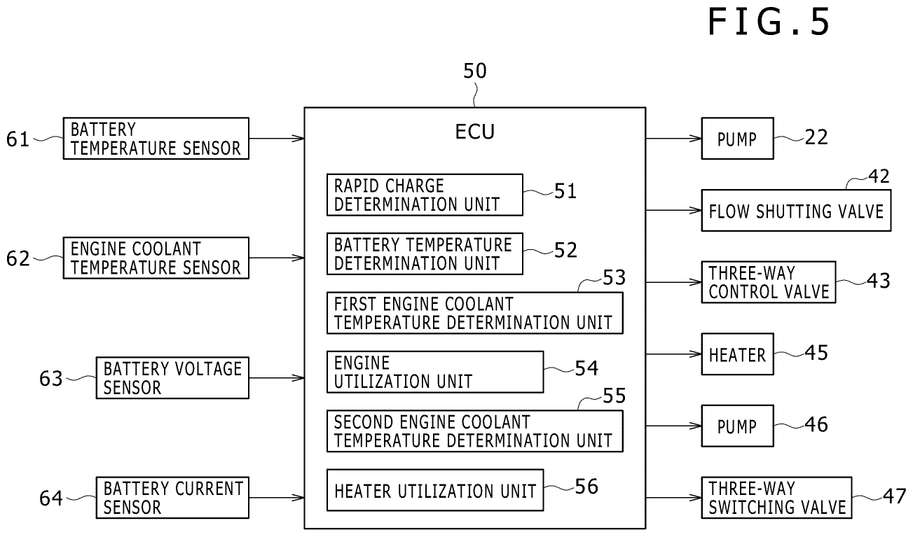

The configuration of the ECU 50 serving as a control unit will be described with reference to FIGS. 1 and 5.

During rapid charging of the battery 12, the ECU 50 executes battery temperature rise control to raise the temperature of the battery 12 by exhaust heat of the engine 11 and/or heating of the heater 45. According to the ECU 50, the temperature of the battery 12 can be efficiently increased by heating by the heater 45 after heating by the exhaust heat of the engine 11, which will be described later in detail.

As shown in FIGS. 1 and 5, the ECU 50 is connected to a pump 22, a flow shutting valve 42, a three-way control valve 43, a heater 45, a pump 46, a three-way switching valve 47, a battery temperature sensor 61, an engine coolant temperature sensor 62, a battery voltage sensor 63, and a battery current sensor 64.

The battery temperature sensor 61 detects the temperature of the battery 12. The battery temperature sensor 61 is provided near the battery 12. The engine coolant temperature sensor 62 detects the temperature of the engine coolant in the engine coolant circuit 30. The engine coolant temperature sensor 62 is provided, for example, on the downstream side of the engine 11 in the engine cooling path 31. The battery voltage sensor 63 detects the voltage of the battery 12. The battery current sensor 64 detects a current related to charge and discharge of the battery 12.

The ECU 50 includes a CPU (Central Processing Unit) serving as an arithmetic processing unit, a storage unit such as a RAM (Random Access Memory) and a ROM (Read Only Memory), and performs signal processing according to a program stored in advance in the ROM while using a temporary storage function of the RAM.

As shown in FIG. 5, the ECU 50 includes a rapid charge determination unit 51, a battery temperature determination unit 52, a first engine coolant temperature determination unit 53, an engine exhaust heat utilization unit 54, a second engine coolant temperature determination unit 55, and a heater utilization unit 56, each of which will be described later in detail. The rapid charge determination unit 51, the battery temperature determination unit 52, the first engine coolant temperature determination unit 53, the engine exhaust heat utilization unit 54, the second engine coolant temperature determination unit 55, and the heater utilization unit 56 are implemented by the CPU executing a program stored in the ROM or the RAM.

The rapid charge determination unit 51 determines whether or not the charge is rapid charge based on the current and voltage at the time of charge of the battery 12 detected by the battery voltage sensor 63 and the battery current sensor 64. When separate connectors are used for rapid charging and ordinary charging, whether or not the charging is rapid may be determined based on the connectors (charging circuits) used.

The battery temperature determination unit 52 determines whether or not the temperature of the battery 12 detected by the battery temperature sensor 61 is equal to or higher than a predetermined temperature. The predetermined temperature is determined based on a temperature at which battery characteristics such as discharge characteristics are degraded in at least one embodiment.

The first engine coolant temperature determination unit 53 determines whether or not the temperature of the engine coolant detected by the engine coolant temperature sensor 62 is higher than the temperature of the battery 12.

The engine exhaust heat utilization unit 54 sets the engine cooling water circuit 30 to the first mode described above, and heats the battery 12 at an appropriate temperature only by the exhaust heat of the engine 11. Specifically, the engine exhaust heat utilization unit 54 opens the flow shutting valve 42, adjusts the three-way control valve 43 based on the heating load of the air conditioner and the battery temperature, stops the pump 46, and switches the three-way switching valve 47 to the communication between the heater path 34 and the engine cooling path 31.

According to the engine exhaust heat utilization unit 54, when the temperature of the engine coolant is higher than the temperature of the battery 12, the heater 45 is not operated, and the battery 12 is heated at an appropriate temperature only by the exhaust heat of the engine 11, thereby suppressing an increase in power due to the operation of the heater 45. This makes it possible to efficiently raise the temperature of the battery 12.

The second engine coolant temperature determination unit 55 determines whether or not the difference between the temperature of the engine coolant and the temperature of the battery 12 becomes equal to or lower than a predetermined value. In other words, since the engine 11 is stopped, the second engine coolant temperature determination unit 55 determines whether or not the state in which the battery 12 is heated at an appropriate temperature by the extra heat of the engine coolant is finished without heating the engine coolant.

The heater utilization unit 56 sets the engine cooling water circuit 30 to the second mode described above, and heats the battery 12 at an appropriate temperature by the exhaust heat of the engine 11 and the heater 45. Specifically, the heater utilization unit 56 opens the flow shutting valve 42, adjusts the three-way control valve 43 based on the heating load of the air conditioner and the battery temperature, drives the pump 46, and switches the three-way switching valve 47 to the communication between the heater path 34 and the engine bypass path 36.

According to the heater utilization section 56, the battery 12 is heated at an appropriate temperature by the extra heat of the engine coolant, and then the heater 45 is operated, thereby suppressing an increase in power due to the operation of the heater 45. This makes it possible to efficiently raise the temperature of the battery 12.

### [Battery Temperature Rise Control]

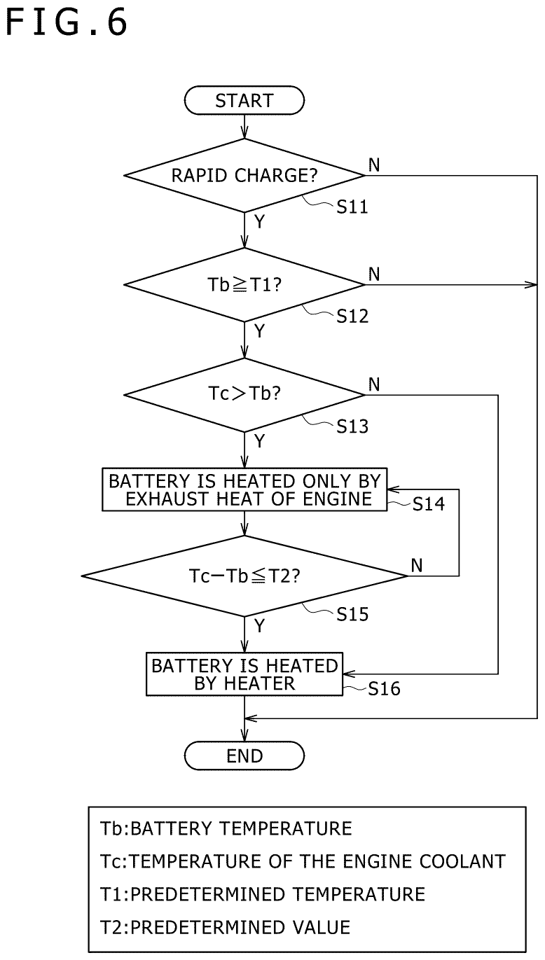

The flow of the battery temperature rise control will be described with reference to FIG. 6.

In the battery temperature raising control, the battery 12 is heated at an appropriate temperature by the battery temperature raising system 10 based on each function of the ECU 50 described above in accordance with the following procedure. In step S11, the rapid charge determination unit 51 determines whether or not the charge is rapid charge based on the current and voltage at the time of charge of the battery 12 detected by the battery voltage sensor 63 and the battery current sensor 64. In the case of rapid charging, the process proceeds to step S12.

In step S12, the battery temperature determination unit 52 determines whether or not the battery temperature detected by the battery temperature sensor 61 is equal to or higher than a predetermined temperature. When the battery temperature is equal to or higher than the predetermined temperature, the process proceeds to step S13.

In step S13, the first engine coolant temperature determination unit 53 determines whether or not the temperature of the engine coolant detected by the engine coolant temperature sensor 62 is higher than the temperature of the battery 12. When the temperature of the engine coolant is higher than the temperature of the battery 12, the process proceeds to step S14. On the other hand, when the temperature of the engine coolant is equal to or lower than the temperature of the battery 12, the process proceeds to step S16.

In step S14, the engine cooling water circuit 30 is switched to the first mode by the engine exhaust heat utilization unit 54, and the battery 12 is heated at an appropriate temperature only by the exhaust heat of the engine 11.

In step S15, the second engine coolant temperature determination unit 55 determines whether or not the difference between the temperature of the engine coolant and the temperature of the battery 12 is equal to or lower than a predetermined value. When the difference between the temperature of the engine coolant and the temperature of the battery 12 becomes equal to or lower than the predetermined temperature, the process proceeds to step S16.

In step S16, the engine cooling water circuit 30 is switched to the second mode by the heater utilization unit 56, and the battery 12 is heated at an appropriate temperature by the exhaust heat of the engine 11 and the heater 45.

It should be noted that the present disclosure is not limited to the above-described embodiments and modifications thereof, and it is needless to say that various changes and modifications can be made without departing from the scope of the claims of the present application.

1. A battery temperature raising system for raising a temperature of a battery, wherein
the battery temperature raising system includes a battery control water circuit configured to cool or heat the battery to a target temperature and an engine cooling water circuit configured to cool an engine,
the engine cooling water circuit has a first path for heating the battery cooling water circuit, a second path for heating air to be blown into a vehicle compartment, and a third path heated by a heater,
the first path is connected in parallel with the second path.

2. The battery temperature raising system according to claim 1, wherein:
the third path is connected in series with the first path and the second path, and
the engine cooling water circuit further comprises a bypass path for bypassing the third path.

3. The battery temperature raising system according to claim 1, wherein:
when the temperature of the battery is (1) equal to or lower than a predetermined temperature and (2) a temperature of water in the engine cooling water circuit is higher than the temperature of the battery, the battery cooling water circuit is heated only by exhaust heat from the engine, and
after the battery cooling water circuit is heated by the exhaust heat from the engine, when the temperature of the battery is (3) equal to or lower than the predetermined temperature and (4) a difference between the temperature of water in the engine cooling water circuit and the temperature of the battery becomes equal to or lower than a predetermined value, the battery cooling water circuit is heated by the heater.

4. The battery temperature raising system according to claim 2, wherein:
when the temperature of the battery is (a) equal to or lower than a predetermined temperature and (2) a temperature of water in the engine cooling water circuit is higher than the temperature of the battery, the battery cooling water circuit is heated only by exhaust heat from the engine, and
after the battery cooling water circuit is heated by the exhaust heat from the engine, when the temperature of the battery is (3) equal to or lower than the predetermined temperature and (4) a difference between the temperature of water in the engine cooling water circuit and the temperature of the battery becomes equal to or lower than a predetermined value, the battery cooling water circuit is heated by the heater.
